(19) United States
(12) Patent Application Publication
(10) Pub. No.: US 2007/0092352 A1
(43) Pub. Date: Apr. 26, 2007

(54) Tamper proof fastener

(76) Inventor: Martin J. Nilsen, Hampshire, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/505,655

(22) Filed: Aug. 17, 2006

Related U.S. Application Data
(60) Provisional application No. 60/729,146, filed on Oct. 21, 2005.

(51) Int. Cl. F16B 31/00

(52) U.S. Cl. 411/5

(57) ABSTRACT

A tamper resistant nut includes a threaded base for engaging a male threaded fastener and a wrenchable body separable from the base. The base has no readily engagable surfaces accommodating standard tools.

### CROSS-REFERENCE TO RELATED APPLICATIONS

The present regular United States Patent Application claims the benefits of United States Provisional Application Ser. No. 60/729,146, filed Oct. 21, 2005.

### FIELD OF THE INVENTION

The present invention relates generally to fasteners such as nuts, and, more particularly, the invention pertains to tamper proof nuts.

### BACKGROUND OF THE INVENTION

Simple threaded fastening systems, such as a nut and bolt or nut and threaded stud, are used often for ease of installation and low cost. Nut and bolt fasteners can be provided in various shapes and sizes suitable for a particular installation. Nuts and bolts also can be provided in various materials best suited for a particular application.

Simple threaded fasteners are easy to use and can be provided relatively inexpensively. In some installations, a simple threaded fastener has disadvantages. The fastener may perform acceptably for the securing function it is used for; however, the fastener may not provide the desired level of security. For example, it is desirable in some instances to limit the ability of others to disconnect a fastener so that the items secured thereby cannot be removed or altered. In other installations it is desirable to make it difficult for unauthorized individuals to have access. For example, it is desirable to limit access of vehicle air bag systems to only trained and authorized technicians. Various specialized fasteners requiring specialized, uncommon tools for manipulation have been used in these situations.

Tamper proof nuts are known; however, some are difficult to install and are costly. A known principle in the design of tamper proof nuts is to provide the nut in shapes that are not easily gripped by hand and not readily engaged by common tools such as wrenches, sockets, pliers and the like. As a result, even for initial installation it may be necessary to have a specialized tool to tighten the nut. Further, manipulating the nut for tightening may be difficult and slow. If the shapes are unusual or non-standard, complex machining may be required to form the nut. Nuts formed by unusual or uncommon techniques can be expensive. If a device or installation requires a large number of fasteners, the use of tamper proof fasteners can increase significantly the cost of the assembly or installation. The difficulty of installation and/or manipulation of a tamper proof fastener can increase labor costs and add further expense to the overall assembly or installation cost.

It is desirable to provide a fastener that is tamper proof after installation, yet is easy to install quickly with conventional tools. Further, it is desirable that the nut be manufacturable by common fastener manufacturing techniques, and that it be provided inexpensively.

### SUMMARY OF THE INVENTION

The present invention provides a threaded fastener similar to a nut, but having a dome-shaped flange or main body with a threaded central opening for engaging a threaded bolt or stud. The flange or main body has no readily wrenchable surfaces. A wrenchable body is connected to the flange by a fracture zone configured for separation of the body from the flange when installation is complete.

In one aspect thereof, the present invention provides a fastener with a base having an exposed surface, a compression surface and a central opening therethrough. A thread is provided in the central opening for engaging a male threaded fastener. A wrenchable body is provided on an opposite side of the base from the compression surface. A failure zone joins the base and the wrenchable body for controlled separation between the base and the wrenchable body.

In another aspect thereof, the present invention provides a tamper resistant nut with a dome shaped base having a thin outer edge, a thicker central portion and a smooth exposed surface from the central portion to the edge. A central opening extends through the base with a thread in the opening. A body aligned with the central opening projects outwardly of the base exposed surface. The body has peripheral wrench engageable surfaces. A failure zone is defmed in the nut for controlled separation of the body from the base.

In a still further aspect thereof, the present invention provides a method of making a threaded fastener with steps of forming a dome shaped base having a substantially flat compression surface on one side thereof and a substantially smooth exposed surface on an opposite side thereof, including establishing a thicker central area and a thin outer periphery in the base; forming a central opening through the base from the compression surface to the exposed surface; creating a thread in the central opening; forming a wrenchable body as a part of a monolithic structure including the base; and creating a failure zone in the monolithic structure between the wrenchable body and the base.

An advantage of the present invention is providing a tamper proof fastener that is easy to install.

Another advantage of the present invention is providing a tamper proof fastener that can be manufactured inexpensively by common techniques.

Still another advantage of the present invention is providing a tamper proof nut that can be manufactured by common nut forming techniques, including cold forming and conventional tapping.

Yet another advantage of the present invention is providing a recessed connection between a frangible drive body and a threaded flange so that the body can be removed without leaving an exposed sharp edge.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a tamper proof fastener in accordance with the present invention;

FIG. 2 is a cross-sectional view of the fastener shown in FIG. 1, the cross-sectional view having been taken along line 2-2 of FIG. 1; and

FIG. 3 is a cross-sectional view of the fastener shown in FIGS. 1 and 2, illustrating the fastener installed in a fastened system after final tightening has been completed.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

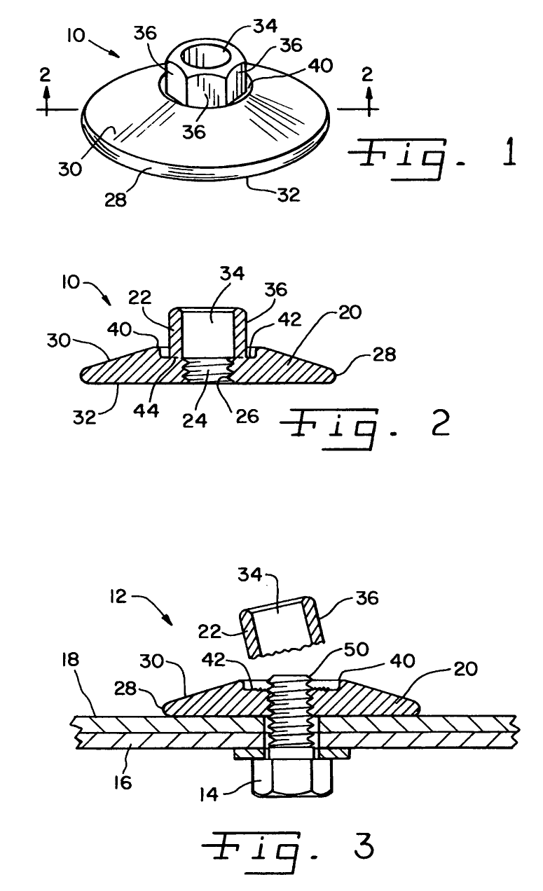

Referring now more specifically to the drawings and to FIG. 1 in particular a tamper proof nut 10 in accordance with the present invention is shown. As illustrated in FIG. 1, tamper proof nut 10 is ready for initial installation. FIG. 3 illustrates tamper proof nut 10 installed in a fastened system 12 including a bolt 14 and first and second panels 16 and 18. It should be understood that system 12 shown in FIG. 3 is merely exemplary in nature, and that tamper proof nuts 10 of the present invention can be used with other types of male threaded fasteners including threaded studs securely mounted in devices, and can be used for securing objects other than panels 16 and 18 as shown. Further, tamper proof nut 10 can be provided in a variety of sizes for use with different size male fasteners and in devices and installations of different types.

Tamper proof nut 10 is a monolithic body having a base 20 and a wrenchable body 22. Base 20 defines a central opening 24 having a thread 26 therein for engaging a male fastener component such as bolt 14. In the exemplary embodiment, base 20 defines a thin, circular outer periphery 28 of insufficient thickness for easy engagement by common tools. Base 20 is thicker near the center thereof and thinner at periphery 28 to establish a smooth, sloping exposed surface 30 for the generally dome-shaped base 20. A flat, compression surface 32 is provided opposite from wrenchable body 22. Compression surface 32 confronts the device upon which nut 10 is used and against which nut 10 is tightened during installation. Accordingly, in fastened system 12 shown in FIG. 3 compression surface 32 is engaged with and confronts panel 18.

Wrenchable body 22 defines an axial opening 34 therethrough. Axial opening 34 is of greater diameter than central opening 24 of base 20. Opening 34 is not threaded and is of sufficient diameter to allow a threaded end of bolt 14 to enter unencumbered and unrestricted. Accordingly, a male fastener component such as bolt 14 does not engage body 22 but can extend upwardly therein when tightening takes place.

Wrenchable body 22 is configured at the outer surface thereof for engagement by conventional tools. In the exemplary embodiment, wrenchable body 22 is provided with a hex-shaped outer configuration including wrenching surfaces 36. Accordingly, as seen most clearly in FIG. 1, wrenchable body 22 appears similar to a conventional hex nut, except for lacking threads in axial opening 34 thereof. It should be understood that other peripheral shapes and configurations for body 22 also can be used. Further, body 22 can be configured for engagement by other tools including drivers such as screwdrivers and other tools operating at and in the end of body 22 and/or axial opening 34 thereof. To facilitate initial installation, configurations for wrenchable body 22 that are conducive to engagement by common wrenches and hand or power tools are used. However, the present invention also can be used with configurations for less-common types of tools as well.

Upper surface 34 defines a depression or countersink 40 therein. Wrenchable body 22 is joined to base 20 at a bottom 42 of depression 40. The area of union between body 22 and base 20 is referred to herein as a failure zone 44 depicted by dashed lines in FIG. 2. As part of the process for forming nut 10, scoring, undercutting or stressing of other types can be provided in failure zone 44 such that a relatively clean break or separation occurs between base 20 and body 22 as described subsequently herein.

In the use of nut 10, central opening 24 is aligned with male thread 50 from a male fastener such as bolt 14, and nut 10 is rotated for engagement of thread 26 and thread 50. A common wrench, such as a socket wrench, box wrench, end wrench or the like can be used to engage wrenchable body 22 for rotation of nut 10. Clamping force is applied as compression surface 32 is engaged against panel 18 and nut 10 is tightened. As final tightening force is applied, fracture occurs along failure zone 44, and wrenchable body 22 separates from base 20. Through forming techniques, failure zone 44 can be provided so that a specified torque is necessary to cause fracture. As a result, a desired clamp load can be provided in fastened system 12 simply by tightening nut 10 until wrenchable body 22 fractures away from base 20.

Even if a portion of bolt 14 extends through base 20 and into body 22, body 22 can be separated from base 20 in that body 22 has no internal threads and does not physically engage bolt 14.

As seen from FIG. 3, after wrenchable body 22 has been separated from base 20, the remaining portion of nut 10 on bolt 14 does not provide readily engagable surfaces or contours for receiving a wrench for turning. Periphery 28 is thin and rounded, thereby making engagement by a wrench difficult. Sloping exposed surface 30 is not conducive to engagement by standard tools.

By providing failure zone 44 at bottom 42 of depression 40, the fractured face or edge that remains after body 22 is separated from base 20 is recessed and protected even if a jagged edge remains. Forming body 22 at the bottom of depression 40 concentrates stresses at failure zone 44 for control, consistent separation.

A tamper proof nut of the present invention can be made of various materials suitable for the application. Because of the simple, yet common shapes of base 20 and body 22, nut 10 is conducive to standard forming techniques, such as cold forming. Threads 26 can be formed by standard tapping equipment. As a result, nuts 10 of the present invention can be provided at acceptable expense. While easily engaged with standard wrenches during installation, after wrenchable body 22 has been fractured away from base 20 and discarded, the remaining shape is not readily engageable by a wrench. Accordingly, initial installation is facilitated by allowing the use of common tools, yet after installation the fastened connection is secure and not easily tampered with.

Nut 10 can be formed as a monolithic body of metal including base 20 and wrenchable body 22 integral therewith. Standard forming processes can be used, such as cold forming. Base 20 and body 22 are formed from a single piece of metal with central opening 24 and axial opening 34 formed in substantial alignment one with the other. Central opening 24 is threaded by standard thread forming techniques, such as tapping. Axial opening 34 is formed with a diameter greater than a diameter of central opening 24. Forming depression 40 in the exposed surface, with wrenchable body 22 formed within depression 40 concentrates stresses along failure zone 44 for controlled separation.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A fastener comprising:
a base having an exposed surface, a compression surface and a central opening therethrough;
a thread in said central opening for engaging a male threaded fastener;
a wrenchable body on an opposite side of said base from said compression surface; and
a failure zone joining said base and said wrenchable body for controlled separation between said base and said wrenchable body.

2. The fastener of claim 1, said wrenchable body having a hex shaped periphery.

3. The fastener of claim 1, said base being thicker near said central opening and thinner toward the periphery thereof.

4. The fastener of claim 3, said wrenchable body having a hex shaped periphery.

5. The fastener of claim 4, said base having a circular periphery.

6. The fastener of claim 5, said base defining a depression around said central opening, said depression having a bottom, and said wrenchable body being at least partly disposed in said depression.

7. The fastener of claim 6, said failure zone being at said bottom of said depression.

8. The fastener of claim 1, said base having a circular periphery.

9. The fastener of claim 1, said base being dome-shaped and said exposed surface being smooth.

10. A tamper resistant nut, comprising:
a dome shaped base having a thin outer edge, a thicker central portion and a smooth exposed surface from said central portion to said edge;
a central opening in said base;
a thread in said central opening;
a body integral with said base and aligned with said central opening, said body projecting outwardly of said base exposed surface and having peripheral wrench engageable surfaces; and
a failure zone defined in said nut for controlled separation of said body from said base.

11. The tamper resistant nut of claim 10, said body having a hex shaped periphery.

12. The tamper resistant nut of claim 10, said base defining a depression in said exposed surface surrounding said central opening, said body extending outwardly from said depression, and said failure zone defined at a bottom of said depression.

13. The tamper resistant nut of claim 10, said body having an axial opening aligned with said central opening in said base.

14. The tamper resistant nut of claim 13, said axial opening in said body being of greater diameter than said central opening in said base.

15. The tamper resistant nut of claim 14, said body having a hex shaped periphery.

16. The tamper resistant nut of claim 14, said base defining a depression in said exposed surface surrounding said central opening, said body extending outwardly from said depression, and said failure zone defined at a bottom of said depression.

17. The tamper resistant nut of claim 10, said base and said body being a monolithic body of metal.

18. A method of making a threaded fastener, comprising steps of:
forming a dome shaped base having a substantially flat compression surface on one side thereof and a substantially smooth exposed surface on an opposite side thereof, including establishing a thicker central area and a thinner outer periphery in the base;
forming a central opening through the base from the compression surface to the exposed surface;
creating a thread in the central opening;
forming a wrenchable body as a part of a monolithic structure including the base; and
creating a failure zone in the monolithic structure between the wrenchable body and the base.

19. The method of claim 18, including forming an axial opening through the wrenchable body substantially aligned with the central opening.

20. The method of claim 19, including forming the axial opening in the body with a diameter greater than a diameter of the central opening in the base.

21. The method of claim 18, including forming a depression in the exposed surface surrounding the central opening; and forming the body in the depressions with the failure zone at a bottom of the depression.
